(19) United States
(12) Patent Application Publication
(10) Pub. No.: US 2026/0339761 A1
(43) Pub. Date: Oct. 29, 2026

(54) VECTOR COMMUNICATIONS BETWEEN ARTIFICIAL INTELLIGENT AGENTS

(71) Applicant: Microsoft Technology Licensing, LLC, Redmond, WA (US)

(72) Inventors: Sin Yu Bonnie HO, Berlin (DE); Chelsea Ann VILLANUEVA, Seattle, WA (US); Andrew Paul MATHEW, Crofton, MD (US); Kevin Corley WONUS, Haymarket, VA (US)

(21) Appl. No.: 19/189,999

(22) Filed: Apr. 25, 2025

(51) Int. Cl. G06F 9/54

(52) U.S. Cl. CPC G06F 9/546

(57) ABSTRACT

A vector communication engine enables vector-based communications by multiple AI agents by receiving a first vector message from a first AI agent. The first vector message embodies a vector representation format of the first AI agent corresponding to an embedding model used by the first AI agent to generate the first vector message. The first vector message is transmitted as a second vector message to a second AI agent, wherein the second vector message embodies a vector representation format of the second AI agent corresponding to an embedding model used by the second AI agent to process the second vector message.

### BACKGROUND

Language models often work in tandem with artificial intelligent agents (sometimes referred to herein as "intelligent agents" or simply "AI agents"), which tend to communicate between themselves using natural languages. However, natural language communications, even among humans, run the risk of miscommunication where ideas can get "lost in translation" – as translations ensue, meanings become ambiguous, and misunderstandings are induced. Miscommunication can be even more significant when translation is required between different natural languages.

### Summary

In some aspects, the techniques described herein relate to a method of communicating between multiple AI agents, the method including: receiving a first vector message from a first AI agent, wherein the first vector message embodies a vector representation format of the first AI agent corresponding to an embedding model used by the first AI agent to generate the first vector message; and transmitting the first vector message as a second vector message to a second AI agent, wherein the second vector message embodies a vector representation format of the second AI agent corresponding to an embedding model used by the second AI agent to process the second vector message.

In some aspects, the techniques described herein relate to a computing system for communicating between multiple AI agents, the computing system including: memory; one or more hardware processors; and a communication manager stored in the memory, executable by the one or more hardware processors, and configured to receive a first vector message from a first AI agent, wherein the first vector message embodies a vector representation format of the first AI agent, and further configured to transmit the first vector message as a second vector message to a second AI agent, wherein the second vector message embodies a vector representation format of the second AI agent.

In some aspects, the techniques described herein relate to one or more tangible processor-readable storage media embodied with instructions for executing on one or more processors and circuits of a computing device a process for communicating between multiple AI agents, the process including: receiving a first vector message from a first AI agent, wherein the first vector message embodies a vector representation format of the first AI agent; and transmitting the first vector message as a second vector message to a second AI agent, wherein the second vector message embodies a vector representation format of the second AI agent.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Other embodiments are also described and recited herein.

### BRIEF DESCRIPTIONS OF THE DRAWINGS

FIG. 1 illustrates an example system for agentic communications among multiple AI agents.

FIG. 2 illustrates an example vector communication engine for agentic communications between two AI agents.

FIG. 3 illustrates an example flow through a vector communication engine for vector-based agentic communications between two AI agents.

FIG. 4 illustrates example operations for vector-based agentic communications between two AI agents.

FIG. 5 illustrates alternative example operations for vector-based agentic communications between two AI agents.

FIG. 6 illustrates an example computing device for use in implementing the described technology.

### DETAILED DESCRIPTIONS

Communications among multiple language models are referred to as "multi-agent" or "agentic" conversations and are based on natural language messages being passed between different AI agents. For example, using a rock music composition scenario, one might assign one AI agent to the role of a pianist, another to the role of a guitarist, etc. The AI agents in this virtual rock band can cooperatively compose an original rock music song without human supervision, such that insights from one AI agent are shared with one or more other AI agents in the band. Furthermore, the use of individual and/or independent AI agents for each role allows each AI agent to develop its own unique "personality," which can contribute to an enhanced level of originality. However, the integrity of their communications is a factor in determining the results of their composition – if keys, notes, chords, rhythms, lyrics, etc. are not communicated with integrity, the quality of the resulting composition will suffer. Many other examples of AI applications employing agentic conversations may be considered, including, without limitation, an AI application managing an assembly line in which one AI monitors inventory, another monitors power supplied to the assembly line, another synchronizes steps in the assembly line, etc.

In some agentic conversations, each AI agent in a conversation transforms its message from its internal vector representation (also referred to as a feature vector or an embedding) to a natural language representation. This natural language output is typically not a direct or deterministic "translation" but rather the result of a probabilistic language generation process based on patterns learned by an AI model during training. The generated message is then communicated to another AI agent in that natural language representation. The receiving AI agent then tokenizes and vectorizes the natural language message into its own internal vector representation. Accordingly, in a manner somewhat analogous to a party game called "Telephone" (in which several participants whisper a message from person to person in sequence and discover that the last person in the sequence received a very different message than the original message), message meanings can be lost and/or corrupted through these multiple translation, tokenization, and vectorization operations between two or more AI agents, wherein translation refers to the probabilistic language generation process described above. Furthermore, these multiple stages also introduce substantial latency between messages and responses. Another technical benefit arises in the form of more efficient resource utilization in that less memory and storage and fewer compute cycles may be needed because the natural language translation is omitted between different AI agents.

The described technology reduces such information loss and/or corruption (collectively, "data integrity issues") and latency between two AI agents by replacing natural language messages between AI agents with vectorized messages between AI agents. This approach reduces data integrity losses and the latency introduced in the natural language messaging technique by removing ambiguity inherent in natural language communications and by eliminating translations, tokenization, and vectorization of natural language messages by different AI agents. In at least one implementation, the described technology employs a vector communication engine that communicates messages in a vectorized representation between different AI agents. If the AI agents employ different embedding spaces (e.g., resulting in relatively incompatible internal vectorized representations), the vector communication engine transforms messages output by one AI agent into a vectorized representation format that can be interpreted by the other AI agent - information loss is therefore minimized by transforming the first vector representation into a second vector representation using a combination of mathematics and model-specific lookup tables. This mathematical transformation occurs in lieu of translating the first vector representation into English (or any other natural language) and then subsequently translating that translated string into a second vector representation. In short, the approach avoids the proverbial game of "Telephone" and thus minimizes information loss in more direct LLM-to-LLM communication.

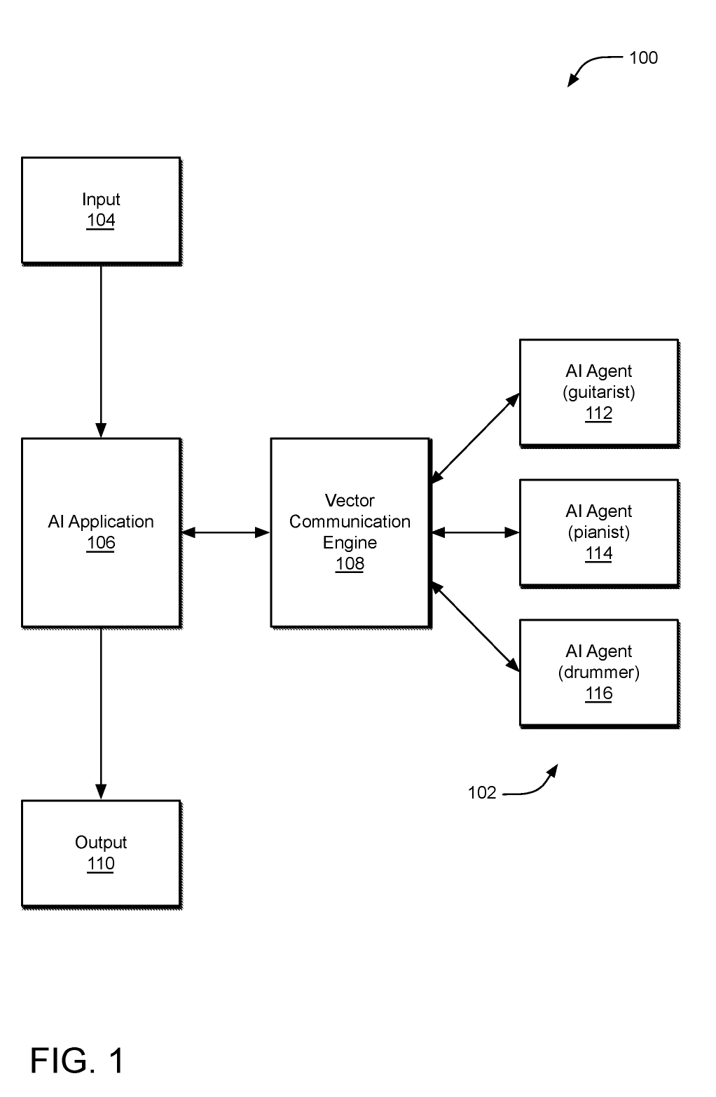

FIG. 1 illustrates an example system 100 for agentic communications among multiple AI agents 102. In an example workflow, input 104 is provided to an AI application 106 (e.g., a natural language prompt asking the AI application 106 to compose a song with guitar, piano, and percussion parts). The input 104 is communicated to a vector communication engine 108 to coordinate communication among the virtual composers (e.g., the AI agents 102), wherein the communication with and between the AI agents 102 is in the form of one or more embedding formats (e.g., vectors) rather than natural language. In this manner, the vector communications provide improved data integrity and reduce latency as the AI agents 102 perform their roles as components in the band. It should be understood that the input 104 may be modified and/or supplemented by the AI application 106 before passing it to the vector communication engine 108.

The AI agents 102 can then process the input 104 requesting a musical composition, with individual AI agents using vector communications to cooperate with other AI agents of AI agents 102 in generating the composition. The composition resulting from the cooperation of the AI agents 102 is returned to the AI application 106 and is output as output 110. It should be understood that the AI application 106 may modify and/or supplement the composition before outputting it as output 110, such as adding metadata, adjusting equalization, changing the sound mix, etc.

More specifically, the system 100 leverages embeddings for vector communications among the AI agents 102. The vector communications are coordinated through a vector communication engine 108, which routes the communications to/from the appropriate AI agents and adapts embedding formats when different AI agents use different and/or incompatible embedding formats. For example, if an AI agent 112 and an AI agent 114 both use a GPT-4o embedding format, the vector communication engine 108 routes messages between these two AI agents without transformation because their embedding formats are the same (or at least compatible). On the other hand, if the AI agent 114 uses a GPT-4o embedding format and an AI agent 116 uses a Mistral 7B embedding format, the vector communication engine 108 detects an incompatibility between the two embedding representation formats and, therefore, transforms one or both sets of messages communicated between these two AI agents to resolve the incompatibility (e.g., by transforming incoming or outgoing messages to GPT-4o or Mistral 7B format) before routing a message from one AI agent to the other.

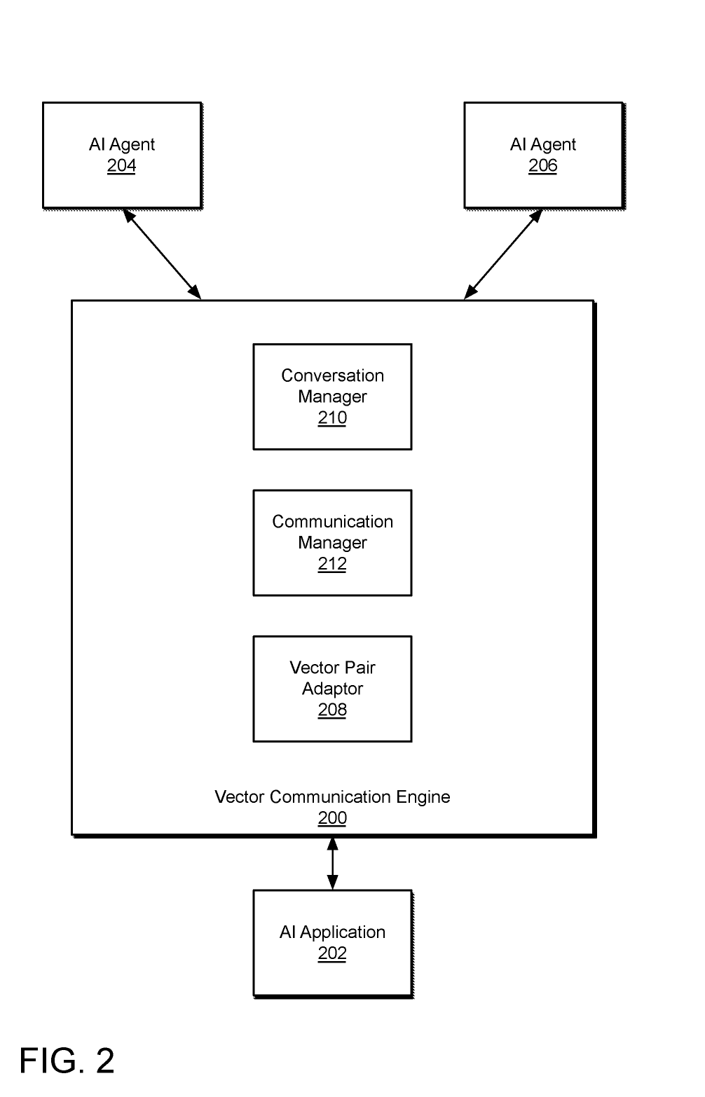

FIG. 2 illustrates an example vector communication engine 200 for agentic communications between two AI agents. An AI application 202 submits an input (e.g., a prompt, a question, or an instruction received from a user or computing system) to the vector communication engine 200, which routes the input to one or more appropriate AI agents, such as an AI agent 204 and an AI agent 206. The AI agents may include language models (e.g., large or small) and other artificial intelligence models, some of which may generate vector representation formats that are incompatible with other AI agents participating in the agentic processing for the AI application 202.

An AI agent 204 and an AI agent 206 may employ the same embedding models to generate feature vectors in which their vector representation formats are compatible. On the other hand, if the AI agent 204 and the AI agent 206 employ different embedding models, then their vector representation formats may be incompatible. For example, if the AI agent 204 employs GPT-4o, which uses text-embedding-3 series embedding models to generate feature vectors, and the AI agent 206 employs Mistral 7B, which uses the mistral-embed model to generate feature vectors, then their vector representation formats are incompatible. The different embedding models generate incompatible vector representation formats resulting from one or more of the following (and potentially other characteristics): different dimensionality, different training data used to train the individual embedding models, different underlying architectures of the embedding models, and different tokenization and normalization approaches. When the vector representation formats from the AI agent 204 and the AI agent 206 are incompatible, a vector pair adaptor 208 of the vector communication engine 200 adapts one or both of the vector messages received from the two AI agents into compatible vector representation formats (e.g., translating one vector representation format to the other or translating both vector representation formats into a mutually compatible vector representation format). As an end result, the vector messages output by the different AI agents are already compatible, or the vector messages output by one or both AI agents are modified to be compatible with the other AI agents.

For the purpose of the description of FIG. 2, the vector communication engine 200 receives vector communications from the AI agent 204 and transmits the vector communications to the AI agent 206, but it should be understood that vector communications may be traveling in both directions. A conversation manager 210 of the vector communication engine 200 can perform many functions for the vector communication engine 200, including one or more of the following:
1. AI Agent Registration: The conversation manager 210 captures and maintains a list of AI agents (e.g., Large Language Models (LLMs)) and their associated metadata to register these AI Agents for the agentic conversation.
2. Metadata Management: The conversation manager 210 stores and processes the metadata associated with each AI agent. The metadata may include details for managing the conversation and ensuring efficient communication between different AI agents.
3. Coordination with a communication manager 212: The conversation manager 210 interacts with the communication manager 212 to facilitate the transmission of vector messages. When an AI agent submits a vector message, the conversation manager 210 broadcasts the vector message to all other registered AI agent listeners.
4. Transformation Coordination: If a vector message requires transformation (e.g., converting embeddings from the vector representation format of one AI agent to that of another AI agent), the conversation manager 210 coordinates with the vector pair adaptor 208 to perform these transformations before broadcasting the information to the other AI agents.
5. Error Reporting: The conversation manager 210 manages acknowledgments (ACKs) and negative acknowledgments (NACKs) for the registration and transformation processes, thereby assisting in the identification and resolution of issues that arise during the conversation.
6. Dynamic Loading: The conversation manager 210 dynamically loads necessary libraries for embedding/vector transformations, enabling the system to remain resilient and adaptive to new embedding models as they become available.
7. Audit Logging: The conversation manager 210 maintains an audit log to maintain transparency and validation of the communication process. This log can be reviewed to verify that the conversation adheres to responsible AI principles.

These functions enable the Conversation Manager to facilitate efficient, direct communication between AI agents, contributing to the reduction in information loss and latency.

The communication manager 212 of the vector communication engine 200 transmits vector messages received from any peer AI agent in the conversation to all registered AI agent listeners. If the vector representation format of a vector message is compatible with that of a first registered AI agent listener, the vector message is transmitted to that first registered AI agent listener without transformation. If, on the other hand, the vector representation format of a vector message is incompatible with that of a second registered AI agent listener, the communication manager 212 calls the vector pair adaptor 208 to transform and transmit the vector message to the second registered AI agent listener. The evaluation of the vector message format and transformation (as needed) may be performed for all registered AI agent listeners in the conversation.

The vector pair adaptor 208 of the vector communication engine 200 dynamically transforms embeddings between different vector representation formats, enabling efficient inter-agent communication. The vector pair adaptor 208 can perform many functions for the vector communication engine 200, including one or more of the following:
1. Transformation of Embeddings: When two AI agents use different embedding models, the vector pair adaptor 208 converts embeddings from one vector representation format to another. This transformation reduces information loss compared to traditional language translation.
2. Dynamic Loading: The vector pair adaptor 208 relies on dynamic loading for supporting libraries so that it can load the necessary transformation libraries at runtime, making the system both resilient and extensible.
3. Inversion-of-Control (IoC) Design Pattern: By using dynamic loading, the vector pair adaptor 208 follows an IoC design pattern, thereby allowing the system to handle cases where certain transformations are not implemented, notifying the AI agents about any missing transformations. It should be understood that other design approaches may be employed.
4. Efficient Communication: The vector pair adaptor 208 processes communications between AI agents by transforming embeddings on-the-fly (when needed), which helps maintain efficiency and reduce latency in the conversation.

When the AI agents complete their cooperation and generate an output, the output is communicated from the vector communication engine 200 to the AI application 202.

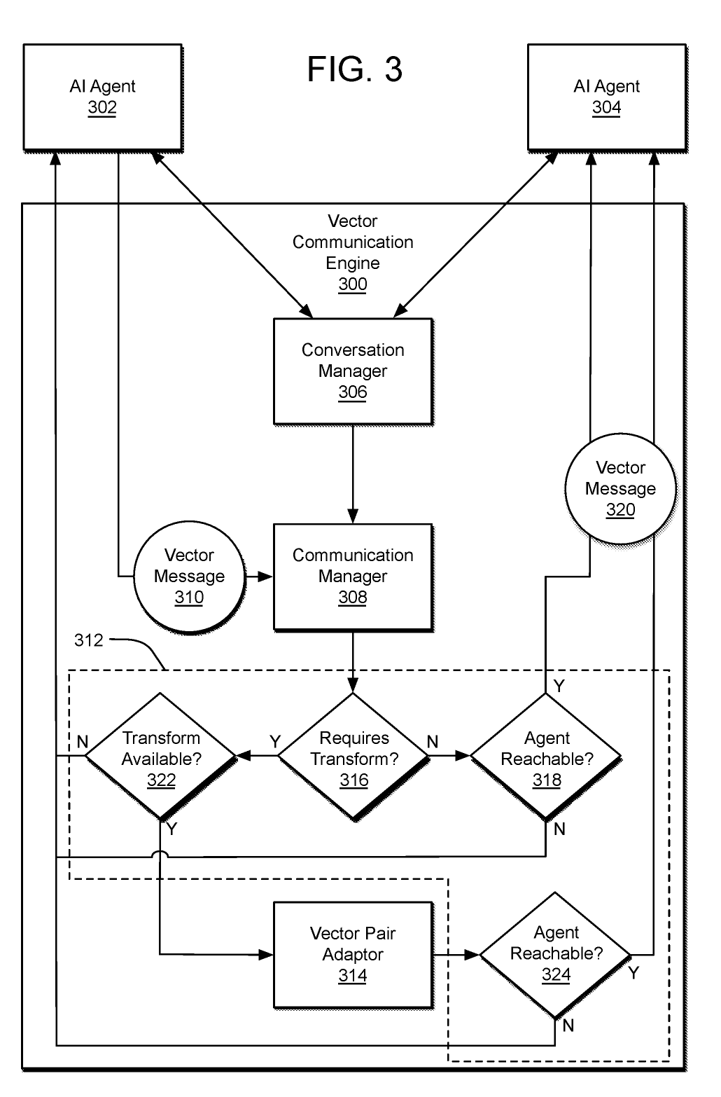

FIG. 3 illustrates an example flow through a vector communication engine 300 for vector-based agentic communications between two AI agents. It is assumed, in this example, that an AI application has requested the generation of a result from the multiple AI agents, and the vector communication engine 300 operates to manage communications between the AI agents. In some implementations, a single vector communication engine 300 may be a single entity operating to coordinate communications of multiple AI agents. In other implementations, the vector communication engine 300 may be distributed to one or more of the AI agents so that each AI agent can perform some or all of the message transformations sent and/or received by that AI agent.

Prior to the execution of any conversation, an AI agent 302 and an AI agent 304 register for the conversation by sending registration requests to a conversation manager 306 of the vector communication engine 300. The conversation manager 306 collects metadata for each AI agent and registers each AI agent in the conversation, if possible, returning notice of a successful registration (ACK) or an unsuccessful registration (NACK) to the corresponding AI agents. Unsuccessful registrations may be retried, and/or a notification is sent to a user or administrator to provide notice of a potential problem. For the purposes of the description of FIG. 3, it is assumed that the registrations were successful.

Registration information pertaining to the AI agents participating in the conversation is sent by the conversation manager 306 to a communication manager 308. In at least one implementation, the registration information for each registered AI agent is communicated via a topic.yml file, which may include one or more of the following items, among other items: an identifier of the AI agent (a URL of the AI agent); a friendly name of the AI agent; the embedding model used by the AI agent, including its dimension; and a communication setting (e.g., send/receive, send-only, receive-only). The communication setting indicates, for example, the AI agent's role in any conversation. An interactive AI agent may indicate a send/receive setting, a monitoring AI agent (e.g., for a sensor) may indicate a send-only setting, and a logging AI agent may indicate a receive-only setting. The communication manager 308 uses this registration information to manage the transformation and communication of vector messages between the AI agents registered for the conversation.

In this illustrated example, assume that an AI agent 302 is sending a vector message to an AI agent 304. Accordingly, having registered with the conversation manager 306, the AI agent 302 sends a vector message 310 to the communication manager 308 of the vector communication engine 300. The vector message 310 may indicate that it is to be broadcast to all registered AI agent listeners in the conversation or identify a specific target AI agent (e.g., the AI agent 304) that is registered in this conversation. The communication manager 308 has received, from the conversation manager 306, the registration information for those AI agents in the conversation. As a result, the communication manager 308 can determine which AI agents are registered to receive the vector message 310 and whether the vector representation formats between the sender and receiver are compatible/incompatible.

The decision blocks in the dashed box 312 may be considered to represent decisions made by the communication manager 308, by a vector pair adaptor 314, or by other aspects of the vector communication engine 300, depending on the implementation. In the first phase of the flow, a decision block 316 determines whether the vector message 310 requires a transform to a compatible vector representation format. If the AI agent 302 and the AI agent 304 have compatible vector representation formats (e.g., were generated by the same type of embedding model), the decision block 316 determines that transformation is not required. As such, the flow progresses to the decision block 318, which determines whether the target AI agent is reachable. If so, the vector message 310 is not transformed and is transmitted to the AI agent 304 as a compatible vector message 320. If not, an error message is sent back to the AI agent 302 indicating that the vector message 310 could not be sent to the AI agent 304.

If, on the other hand, the AI agent 302 and the AI agent 304 have incompatible vector representation formats (e.g., were generated by different/incompatible types of embedding models), the decision block 316 determines that transformation is required. A decision block 322 determines whether the vector communication engine 300 has the information it needs to execute a transformation of the vector message 310 to a compatible format. If not, an error message is sent back to the AI agent 302 indicating that the vector message 310 is incompatible and no appropriate transformation is available. If so, the flow progresses to the vector pair adaptor 314, which executes the appropriate transformation of vector message 310 to a compatible vector message 320. A decision block 324 determines whether the target AI agent is reachable. If so, the compatible vector message 320 is transmitted to the AI agent 304. If not, an error message is sent back to the AI agent 302, indicating that the compatible vector message 320 could not be sent to the AI agent 304.

The vector pair adaptor 314 transforms the vector message 310 to a compatible embedding format of the vector message 320 by first identifying the embedding models used by both the sender (AI agent 302) and the receiver (AI agent 304), as identified in their corresponding registration information. In some implementations, the vector pair adaptor 314 dynamically loads the necessary transformation libraries at runtime, although the statically loaded libraries may also be employed. This library loading may be achieved through operating system calls that load the appropriate library for the desired embedding/vector transformation.

Using the loaded libraries, the vector pair adaptor 314 performs the transformation of embeddings by converting the vector representation from the source embedding model to the target embedding model. In at least one implementation, the transformation process can leverage a hypernetwork, which dynamically adjusts to the specific requirements of the embedding models involved. The hypernetwork achieves the transformation by learning a mapping function between the source and target embedding spaces during training, effectively identifying how similar concepts are represented in each embedding model's vector space. Once trained, the hypernetwork can apply the learned mapping to convert the vectorized message with minimal distortion of the original meaning. In some implementations, the transformation aims to minimize information loss by ensuring that the converted embeddings retain as much of the original semantic meaning as possible. This vector format transformation is more efficient than traditional language translation, which can introduce significant lossy-ness.

If possible, the resulting message is broadcast to all registered AI agent listeners in the conversation or transmitted to a specific target AI agent (e.g., the AI agent 304) that is registered in this conversation. This flow can be applied in all sender-receiver directions among two or more AI agents in an agentic conversation.

When the AI agents have cooperated to generate the result requested by the AI application, that result is passed back to the AI application (e.g., by the vector communication engine 300).

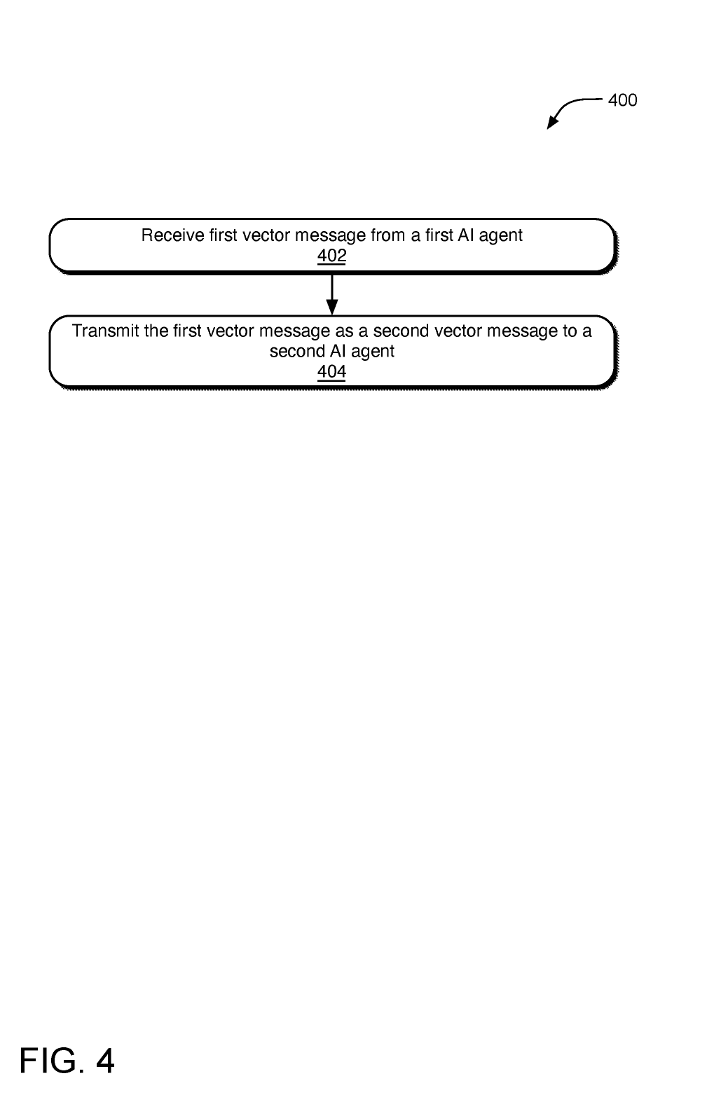

FIG. 4 illustrates example operations 400 for vector-based agentic communications between two AI agents. A receiving operation 402 receives a first vector message from a first AI agent, wherein the first vector message embodies a vector representation format of the first AI agent. The vector representation format of the first AI agent corresponds to the embedding model used by the first AI agent to generate the first vector message. A transmitting operation 404 transmits the first vector message as a second vector message to a second AI agent, wherein the second vector message embodies a vector representation format of the second AI agent. The vector representation format of the second AI agent corresponds to the embedding model used by the second AI agent to process (e.g., to understand, to respond to) the second vector message. In some conditions, the first vector message and the second vector message are the same message (or at least have compatible vector representation formats). In other conditions, the first vector message and the second vector message are differently formatted messages.

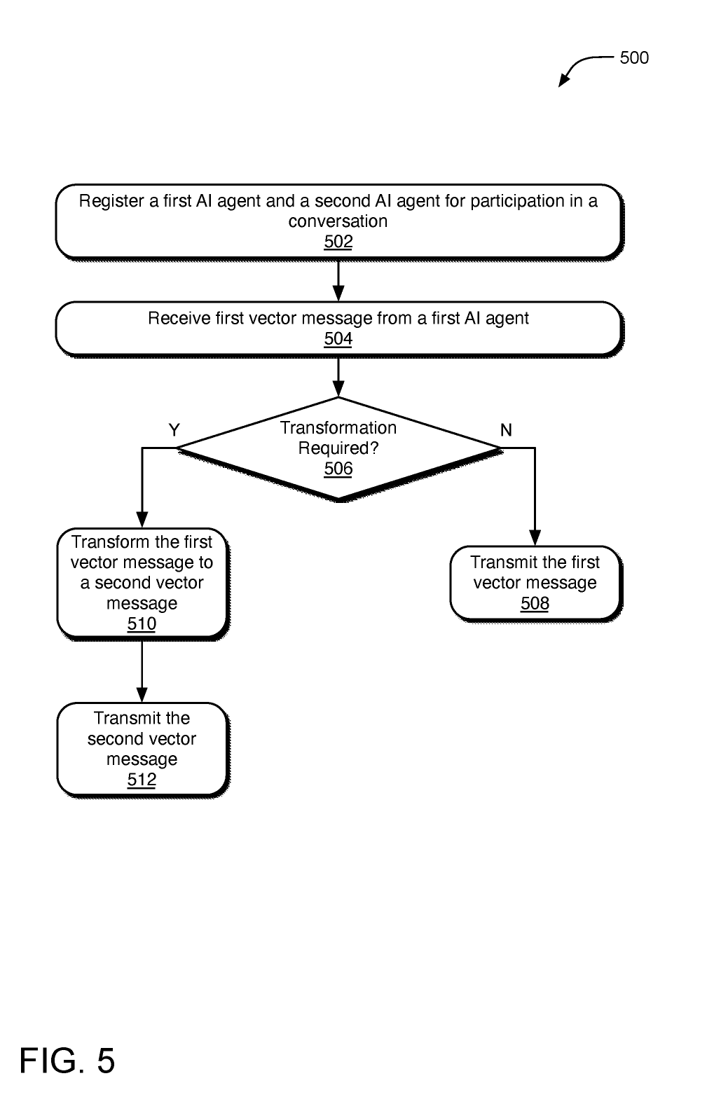

FIG. 5 illustrates alternative example operations 500 for vector-based agentic communications between two AI agents. A registering operation 502 registers a first AI agent and a second AI agent for participation in a conversation. The registration is based on registration information provided by the first AI agent and the second AI agent, wherein the registration information includes an identifier of an AI agent and an identifier of an embedding model used by the AI agent.

A receiving operation 504 receives a first vector message from a first AI agent, wherein the first vector message embodies a vector representation format of the first AI agent. The vector representation format of the first AI agent corresponds to the embedding model used by the first AI agent to generate the first vector message.

A decision operation 506 determines whether a vector representation format transformation is required (e.g., whether the vector representation formats of the first AI agent and the second AI agent are incompatible). In one implementation, this determination is whether the two AI agents employ the same embedding model (e.g., the same type of embedding model, such as the same text-embedding-3 series embedding model). In other implementations, different embedding models may still be compatible, albeit with some differences in the models themselves. If no transformation is required, then a transmitting operation 508 transmits the first vector message to the second AI agent, wherein the first vector message embodies a vector representation format that is compatible with the second AI agent. In this condition, the first vector message and the second vector message are the same message (or at least have compatible vector representation formats).

If a transformation is required, a transforming operation 510 transforms the first vector to a second vector message having a vector representation format that is compatible with the requirements of the second AI agent. In this condition, the first vector message and the second vector message are differently formatted messages. A transmitting operation 512 transmits the second vector message to the second AI agent, wherein the second vector message embodies a vector representation format that is compatible with the second AI agent.

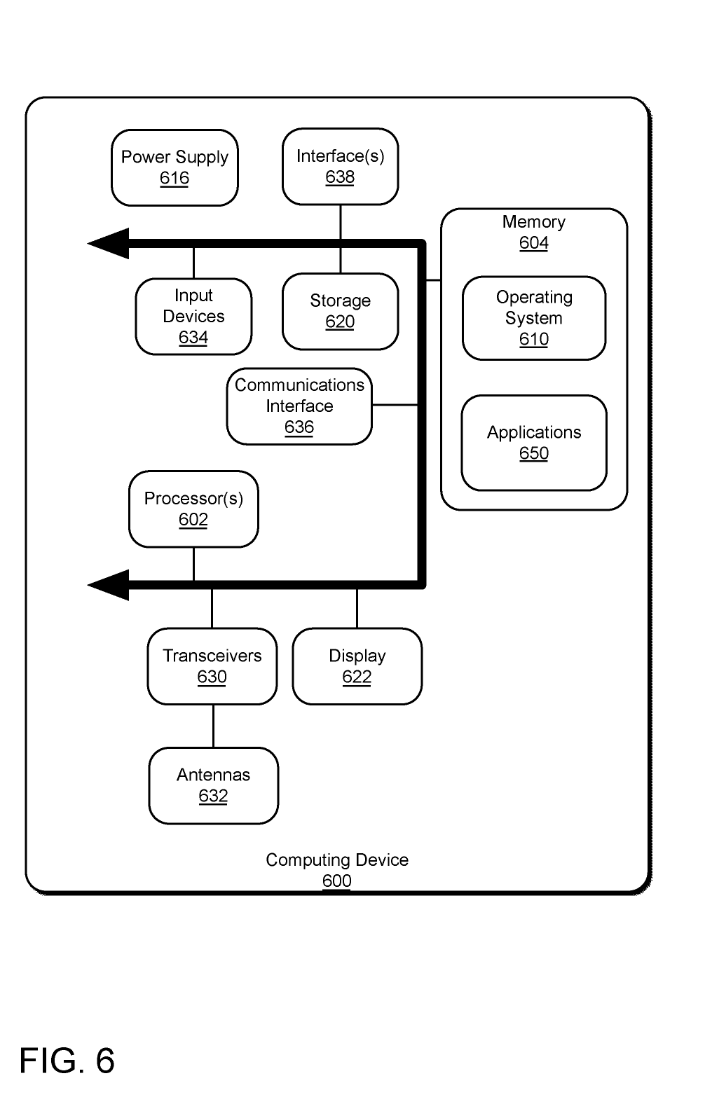

FIG. 6 illustrates an example computing device 600 for use in implementing the described technology. The computing device 600 may be a client computing device (such as a laptop computer, a desktop computer, or a tablet computer), a server/cloud computing device, an Internet-of-Things (IoT), any other type of computing device, or a combination of these options. The computing device 600 includes one or more hardware processor(s) 602 and a memory 604. The memory 604 generally includes both volatile memory (e.g., RAM) and nonvolatile memory (e.g., flash memory), although one or the other type of memory may be omitted. An operating system 610 resides in the memory 604 and is executed by the processor(s) 602. In some implementations, the computing device 600 includes and/or is communicatively coupled to storage 620.

In the example computing device 600, as shown in FIG. 6, one or more software modules, segments, and/or processors, such as applications 650, AI agents, a vector communication engine, a conversation manager, a communication manager, a vector pair adaptor, an AI application, and other program code and modules are loaded into the operating system 610 on the memory 604 and/or the storage 620 and executed by the processor(s) 602. The storage 620 may store registration information, inputs, outputs, transformations, vector messages, and other data and be local to the computing device 600 or may be remote and communicatively connected to the computing device 600. In particular, in one implementation, components of a system for communicating between multiple AI agents may be implemented entirely in hardware or in a combination of hardware circuitry and software.

The computing device 600 includes a power supply 616, which may include or be connected to one or more batteries or other power sources, and which provides power to other components of the computing device 600. The power supply 616 may also be connected to an external power source that overrides or recharges the built-in batteries or other power sources.

The computing device 600 may include one or more communication transceivers 630, which may be connected to one or more antenna(s) 632 to provide network connectivity (e.g., mobile phone network, Wi-Fi®, Bluetooth®) to one or more other servers, client devices, IoT devices, and other computing and communications devices. The computing device 600 may further include a communications interface 636 (such as a network adapter or an I/O port, which are types of communication devices). The computing device 600 may use the adapter and any other types of communication devices for establishing connections over a wide-area network (WAN) or local-area network (LAN). It should be appreciated that the network connections shown are exemplary and that other communications devices and means for establishing a communications link between the computing device 600 and other devices may be used.

The computing device 600 may include one or more input devices 634 such that a user may enter commands and information (e.g., a keyboard, trackpad, or mouse). These and other input devices may be coupled to the server by one or more interfaces 638, such as a serial port interface, parallel port, or universal serial bus (USB). The computing device 600 may further include a display 622, such as a touchscreen display.

The computing device 600 may include a variety of tangible processor-readable storage media and intangible processor-readable communication signals. Tangible processor-readable storage can be embodied by any available media that can be accessed by the computing device 600 and can include both volatile and nonvolatile storage media and removable and non-removable storage media. Tangible processor-readable storage media excludes intangible and transitory communications signals (such as signals per se) and includes volatile and nonvolatile, removable and non-removable storage media implemented in any method, process, or technology for storage of information such as processor-readable instructions, data structures, program modules, or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 600. In contrast to tangible processor-readable storage media, intangible processor-readable communication signals may embody processor-readable instructions, data structures, program modules, or other data resident in a modulated data signal, such as a carrier wave or other signal transport mechanism. The term "modulated data signal" means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Clause 1. A method of communicating between multiple AI agents, the method comprising: receiving a first vector message from a first AI agent, wherein the first vector message embodies a vector representation format of the first AI agent corresponding to an embedding model used by the first AI agent to generate the first vector message; and transmitting the first vector message as a second vector message to a second AI agent, wherein the second vector message embodies a vector representation format of the second AI agent corresponding to an embedding model used by the second AI agent to process the second vector message.

Clause 2. The method of clause 1, further comprising: registering the first AI agent and the second AI agent for participation in a conversation based on registration information provided by the first AI agent and the second AI agent, wherein the registration information includes an identifier of an AI agent and an identifier of an embedding model used by the AI agent.

Clause 3. The method of clause 1, wherein the first vector message and the second vector message embody a compatible vector representation format.

Clause 4. The method of clause 1, wherein the first vector message and the second vector message embody different vector representation formats, and the vector representation format of the first AI agent is incompatible with the vector representation format of the second AI agent.

Clause 5. The method of clause 1, further comprising: determining that the first vector message and the second vector message embody compatible vector representation formats by determining that the first AI agent and the second AI agent employ a compatible embedding model.

Clause 6. The method of clause 1, further comprising: determining that the first vector message and the second vector message embody different vector representation formats; and transforming the first vector message to embody the vector representation format of the second AI agent by generating a mapping between an embedding space of the first AI agent and an embedding space of the second AI agent and converting the first vector message to the vector representation format of the second AI agent based on the mapping.

Clause 7. The method of clause 6, further comprising: determining whether a transform from the vector representation format of the first AI agent to the vector representation format of the second AI agent is available.

Clause 8. A computing system for communicating between multiple AI agents, the computing system comprising: memory; one or more hardware processors; and a communication manager stored in the memory, executable by the one or more hardware processors, and configured to receive a first vector message from a first AI agent, wherein the first vector message embodies a vector representation format of the first AI agent, and further configured to transmit the first vector message as a second vector message to a second AI agent, wherein the second vector message embodies a vector representation format of the second AI agent.

Clause 9. The computing system of clause 8, further comprising: a conversation manager stored in the memory, executable by the one or more hardware processors, and configured to register the first AI agent and the second AI agent for participation in a conversation based on registration information provided by the first AI agent and the second AI agent, wherein the registration information includes an identifier of an AI agent and an identifier of an embedding model used by the AI agent.

Clause 10. The computing system of clause 8, wherein the first vector message and the second vector message embody a compatible vector representation format.

Clause 11. The computing system of clause 8, wherein the first vector message and the second vector message embody different vector representation formats, and the vector representation format of the first AI agent is incompatible with the vector representation format of the second AI agent.

Clause 12. The computing system of clause 8, wherein the communication manager is further configured to determine that the first vector message and the second vector message embody compatible vector representation formats by determining that the first AI agent and the second AI agent employ a compatible embedding model.

Clause 13. The computing system of clause 8, wherein the communication manager is further configured to determine that the first vector message and the second vector message embody different vector representation formats, and further comprising: a vector pair adaptor stored in the memory, executable by the one or more hardware processors, and configured to transform the first vector message to embody the vector representation format of the second AI agent by generating a mapping between an embedding space of the first AI agent and an embedding space of the second AI agent and converting the first vector message to the vector representation format of the second AI agent based on the mapping.

Clause 14. The computing system of clause 13, wherein the communication manager is further configured to determine whether a transform from the vector representation format of the first AI agent to the vector representation format of the second AI agent is available.

Clause 15. One or more tangible processor-readable storage media embodied with instructions for executing on one or more processors and circuits of a computing device a process for communicating between multiple AI agents, the process comprising: receiving a first vector message from a first AI agent, wherein the first vector message embodies a vector representation format of the first AI agent; and transmitting the first vector message as a second vector message to a second AI agent, wherein the second vector message embodies a vector representation format of the second AI agent.

Clause 16. The one or more tangible processor-readable storage media of clause 15, further comprising: registering the first AI agent and the second AI agent for participation in a conversation based on registration information provided by the first AI agent and the second AI agent, wherein the registration information includes an identifier of an AI agent and an identifier of an embedding model used by the AI agent.

Clause 17. The one or more tangible processor-readable storage media of clause 15, wherein the first vector message and the second vector message embody a compatible vector representation format.

Clause 18. The one or more tangible processor-readable storage media of clause 15, wherein the first vector message and the second vector message embody different vector representation formats, and the vector representation format of the first AI agent is incompatible with the vector representation format of the second AI agent.

Clause 19. The one or more tangible processor-readable storage media of clause 15, further comprising: determining that the first vector message and the second vector message embody compatible vector representation formats by determining that the first AI agent and the second AI agent employ a compatible embedding model.

Clause 20. The one or more tangible processor-readable storage media of clause 15, further comprising: determining that the first vector message and the second vector message embody different vector representation formats; and transforming the first vector message to embody the vector representation format of the second AI agent by training a hypernetwork to map between an embedding space of the first AI agent and an embedding space of the second AI agent and executing the hypernetwork to convert the first vector message to the vector representation format of the second AI agent based on the mapping.

Clause 21. A system for communicating between multiple AI agents, the system comprising: means for receiving a first vector message from a first AI agent, wherein the first vector message embodies a vector representation format of the first AI agent corresponding to an embedding model used by the first AI agent to generate the first vector message; and means for transmitting the first vector message as a second vector message to a second AI agent, wherein the second vector message embodies a vector representation format of the second AI agent corresponding to an embedding model used by the second AI agent to process the second vector message.

Clause 22. The system of clause 21, further comprising: means for registering the first AI agent and the second AI agent for participation in a conversation based on registration information provided by the first AI agent and the second AI agent, wherein the registration information includes an identifier of an AI agent and an identifier of an embedding model used by the AI agent.

Clause 23. The system of clause 21, wherein the first vector message and the second vector message embody a compatible vector representation format.

Clause 24. The system of clause 21, wherein the first vector message and the second vector message embody different vector representation formats, and the vector representation format of the first AI agent is incompatible with the vector representation format of the second AI agent.

Clause 25. The system of clause 21, further comprising: means for determining that the first vector message and the second vector message embody compatible vector representation formats by determining that the first AI agent and the second AI agent employ a compatible embedding model.

Clause 26. The system of clause 21, further comprising: means for determining that the first vector message and the second vector message embody different vector representation formats; and means for transforming the first vector message to embody the vector representation format of the second AI agent by generating a mapping between an embedding space of the first AI agent and an embedding space of the second AI agent and converting the first vector message to the vector representation format of the second AI agent based on the mapping.

Clause 27. The method of clause 26, further comprising: means for determining whether a transform from the vector representation format of the first AI agent to the vector representation format of the second AI agent is available.

Some implementations may comprise an article of manufacture, which excludes software per se. An article of manufacture may comprise a tangible storage medium to store logic and/or data. Examples of a storage medium may include one or more types of computer-readable storage media capable of storing electronic data, including volatile memory or nonvolatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable types of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled, and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A method of communicating between multiple AI agents, the method comprising:
receiving a first vector message from a first AI agent, wherein the first vector message embodies a vector representation format of the first AI agent corresponding to an embedding model used by the first AI agent to generate the first vector message; and
transmitting the first vector message as a second vector message to a second AI agent, wherein the second vector message embodies a vector representation format of the second AI agent corresponding to an embedding model used by the second AI agent to process the second vector message.

2. The method of claim 1, further comprising:
registering the first AI agent and the second AI agent for participation in a conversation based on registration information provided by the first AI agent and the second AI agent, wherein the registration information includes an identifier of an AI agent and an identifier of an embedding model used by the AI agent.

3. The method of claim 1, wherein the first vector message and the second vector message embody a compatible vector representation format.

4. The method of claim 1, wherein the first vector message and the second vector message embody different vector representation formats, and the vector representation format of the first AI agent is incompatible with the vector representation format of the second AI agent.

5. The method of claim 1, further comprising:
determining that the first vector message and the second vector message embody compatible vector representation formats by determining that the first AI agent and the second AI agent employ a compatible embedding model.

6. The method of claim 1, further comprising:
determining that the first vector message and the second vector message embody different vector representation formats; and
transforming the first vector message to embody the vector representation format of the second AI agent by generating a mapping between an embedding space of the first AI agent and an embedding space of the second AI agent and converting the first vector message to the vector representation format of the second AI agent based on the mapping.

7. The method of claim 6, further comprising:
determining whether a transform from the vector representation format of the first AI agent to the vector representation format of the second AI agent is available.

8. A computing system for communicating between multiple AI agents, the computing system comprising:
memory;
one or more hardware processors; and
a communication manager stored in the memory, executable by the one or more hardware processors, and configured to receive a first vector message from a first AI agent, wherein the first vector message embodies a vector representation format of the first AI agent, and further configured to transmit the first vector message as a second vector message to a second AI agent, wherein the second vector message embodies a vector representation format of the second AI agent.

9. The computing system of claim 8, further comprising:
a conversation manager stored in the memory, executable by the one or more hardware processors, and configured to register the first AI agent and the second AI agent for participation in a conversation based on registration information provided by the first AI agent and the second AI agent, wherein the registration information includes an identifier of an AI agent and an identifier of an embedding model used by the AI agent.

10. The computing system of claim 8, wherein the first vector message and the second vector message embody a compatible vector representation format.

11. The computing system of claim 8, wherein the first vector message and the second vector message embody different vector representation formats, and the vector representation format of the first AI agent is incompatible with the vector representation format of the second AI agent.

12. The computing system of claim 8, wherein the communication manager is further configured to determine that the first vector message and the second vector message embody compatible vector representation formats by determining that the first AI agent and the second AI agent employ a compatible embedding model.

13. The computing system of claim 8, wherein the communication manager is further configured to determine that the first vector message and the second vector message embody different vector representation formats, and further comprising:
a vector pair adaptor stored in the memory, executable by the one or more hardware processors, and configured to transform the first vector message to embody the vector representation format of the second AI agent by generating a mapping between an embedding space of the first AI agent and an embedding space of the second AI agent and converting the first vector message to the vector representation format of the second AI agent based on the mapping.

14. The computing system of claim 13, wherein the communication manager is further configured to determine whether a transform from the vector representation format of the first AI agent to the vector representation format of the second AI agent is available.

15. One or more tangible processor-readable storage media embodied with instructions for executing on one or more processors and circuits of a computing device a process for communicating between multiple AI agents, the process comprising:
receiving a first vector message from a first AI agent, wherein the first vector message embodies a vector representation format of the first AI agent; and
transmitting the first vector message as a second vector message to a second AI agent, wherein the second vector message embodies a vector representation format of the second AI agent.

16. The one or more tangible processor-readable storage media of claim 15, further comprising:
registering the first AI agent and the second AI agent for participation in a conversation based on registration information provided by the first AI agent and the second AI agent, wherein the registration information includes an identifier of an AI agent and an identifier of an embedding model used by the AI agent.

17. The one or more tangible processor-readable storage media of claim 15, wherein the first vector message and the second vector message embody a compatible vector representation format.

18. The one or more tangible processor-readable storage media of claim 15, wherein the first vector message and the second vector message embody different vector representation formats, and the vector representation format of the first AI agent is incompatible with the vector representation format of the second AI agent.

19. The one or more tangible processor-readable storage media of claim 15, further comprising:
determining that the first vector message and the second vector message embody compatible vector representation formats by determining that the first AI agent and the second AI agent employ a compatible embedding model.

20. The one or more tangible processor-readable storage media of claim 15, further comprising:
determining that the first vector message and the second vector message embody different vector representation formats; and
transforming the first vector message to embody the vector representation format of the second AI agent by training a hypernetwork to map between an embedding space of the first AI agent and an embedding space of the second AI agent and executing the hypernetwork to convert the first vector message to the vector representation format of the second AI agent based on the mapping.
